(19) United States
(12) Patent Application Publication
(10) Pub. No.: US 2024/0399606 A1
(43) Pub. Date: Dec. 5, 2024

(54) Printing and perforating machine

(71) Applicant: OPEN MIND VENTURES, S.L.U., IGUALADA (Barcelona) (ES)

(72) Inventors: Antoni GUIMERÀ PEDROLA, IGUALADA (Barcelona) (ES); Antoni BALSELLS MERCADE, IGUALADA (Barcelona) (ES)

(21) Appl. No.: 18/690,428

(22) PCT Filed: Sep. 8, 2022
(86) PCT No.: PCT/EP2022/074943

§ 371 Date: Aug. 10, 2024

(30) Foreign Application Priority Data
Sep. 8, 2021 (EP) 21382807.2

(51) Int. Cl. B26F 1/24; B26D 7/20; B26F 1/22; B41G 7/00; B65H 35/08

(52) U.S. Cl. CPC B26F 1/24; B26D 7/204; B26F 1/22; B41G 7/006; B65H 35/08

(57) ABSTRACT

Printing and perforating machine comprising a perforating mechanism (1) and a printing mechanism (30), the perforating mechanism (1) comprising a perforating element (2, 7) provided with piercing elements (5); and a support element (4, 8) that defines with the perforating element (2, 7) a space for the passage of a sheet material (3), forming holes on the sheet material (3) when it passes through this space. With this machine, the perforation of the sheet material is carried out during the printing process thereof, preferably a digital printing, in a synchronized way, eliminating time and handling for loading and unloading the roll of sheet material in a conventional sheet material perforating machine.

The present invention relates to a printing and perforating machine that can print and perforate a sheet material, such as paper, plastic, fabric, etc.

### BACKGROUND OF THE INVENTION

At present the perforation of the sheet material is carried out in specialized machines for this task. In such machines a roll of non-perforated sheet material is loaded, and the machine unwinds, punches, and rewinds the sheet material again, creating a roll of perforated sheet material.

It is a costly process energetically and by the process itself, since the rolls have to be loaded and unloaded and also the perforating process has a long duration involving high maintenance costs. Current processes have additional complexity if the perforations are very dense and the holes with very small diameters, increasing their cost exponentially.

If necessary, said rolls can be subsequently loaded into a printing machine in which the sheet material is printed.

Therefore, if the sheet material is perforated and printed, two separate operations must be carried out, and both operations separately involve a low performance, considering the required time.

### DESCRIPTION OF THE INVENTION

An object of the present invention is to provide a printing and perforating machine, which can print and perforate the sheet material, thus reducing handling time, energy, and costs.

The printing and perforating machine according to the present invention is defined in claim 1. Additional optional features are defined in the dependent claims.

With the printing and perforating machine of the present invention, the perforation of the sheet material is carried out during the printing process thereof, preferably a digital printing, in a synchronized way, eliminating time and handling for loading and unloading the roll of sheet material in a conventional sheet material perforating machine.

Therefore, with the printing and perforating machine of the present invention, the aforementioned drawbacks are solved, presenting other advantages that will be described below.

The perforating mechanism can be located in different areas of the printing machine, depending on its position it will perform the perforation before printing or after printing. The location can be chosen according to the type and need of this perforation and/or the design of the different elements: loading area, printing mechanism, sheet material advance system, etc.

Among others, possible embodiments described below can be considered, the main ones being:

Perforation by advancing the sheet material in the longitudinal axis.

In this embodiment, the perforation of the sheet material will be carried out through a perforating roller and a sheet material support roller that allows the penetration of the piercing elements. The perforation is carried out during the longitudinal movement of the sheet material.

This longitudinal advance of the sheet material can coincide with the advance necessary for printing, although it is not essential, by changing with the various arrangements and location of the perforating rollers.

The perforation function is performed by the perforating roller(s). These rollers have a width equal to or greater than that of the sheet material.

The rollers have piercing elements arranged on their surface. These are pointed, circular, slightly rectangular, square, triangular micro punches with different shapes, lengths and sizes using bar, rolled, drawn, injected, materials etc. suitable for perforation.

These piercing elements protrude slightly from the surface of the roller, this distance being the one that penetrates the sheet material, piercing it, and penetrating the support rollers of this sheet material. Rollers can also be made with die-cutting punches that do not end in a point.

The shape, size, and spacing of these piercing elements determine the shape, size, and density of the resulting holes since the perforating roller comes into contact with the sheet material at a rotating tangent point that covers the full width of the sheet material. The sheet material is perforated only when it advances longitudinally.

Generally, although not necessarily, these perforating rollers require a counter roller for the support of the sheet material—except if the tension of the sheet material is enough—that allows the piercing elements to be inserted into it. These rollers can be formed by individual holes or channels that coincide with the protruding piercing elements where they are inserted. Rollers can be made of materials that allow the penetration of piercing elements on their surface, we could, in this case, make rollers made of rubber, foam, or made of bristles arranged with the appropriate density on their surface.

This perforating mechanism is simple in design, but on the contrary, it requires a very efficient dimensioning of the powers—in general high—of the motors and the systems for advancing the sheet material, as well as the rigidity of the wide rollers that constitute it. This is because the entire width of the sheet material is perforated.

Perforation by transversal advance across the width of the perforating head with respect to the sheet material.

In this embodiment, the perforation of the sheet material will be carried out by a head or carriage that moves transversely, while the sheet material does not advance, to perforate the sheet material by means of one or more perforating wheels contained in said head.

This embodiment requires that the sheet material does not move longitudinally, that it is static at the time of being punched. It is due to the fact that the piercing element/s is/are supported on a head that moves transversely during perforation, bringing the perforating wheels into contact with the sheet material. If the sheet material had longitudinal movement, said perforating wheels, as they did not have longitudinal movement, would tear the sheet material itself in the area of contact with the piercing elements of the perforating wheels.

It is obvious to a skilled person that during the time that the sheet material does not move longitudinally, the machine can print, punch, or cross-cut the sheet material.

Digital printing machines have functions that preferably, although not in a unique way, are carried out through carriages or heads that move transversely, across the width, with respect to the longitudinal displacement axis of the sheet material. These elements are the printing head or carriage where the elements that allow printing are housed, the cutter head or carriage where the blades that cut the sheet material transversely are located and the perforation heads or carriages themselves, where the wheels that contain the piercing elements are housed.

These transverse displacement heads or carriages can be located in different positions between them, varying with the design of the machine and altering the order in which each specific function is performed. They can also form groups that work simultaneously or synchronously, optimizing the necessary transversal movements to carry out their functionality. Thus, individual or hybrid function heads can be designed.

Perforating heads, regardless of whether they are individual or hybrid, have to be robustly designed to ensure that the forces necessary for perforating are applied to the perforating wheels along the entire transverse path. For this, elastic pressing elements are necessary, such as springs, strips, gas pistons and even elastic polyurethane-type polymers for this purpose.

These perforating wheels are made up of piercing elements arranged on their surface. These are pointed, circular, slightly rectangular, square, triangular micro punches, etc. These elements protrude slightly from the surface of the wheel, this distance being the one that penetrates the sheet material by perforating it. Wheels can also be made with die-cutting punches that do not end in a point.

Generally, although not necessarily, these perforating wheels require a surface to support the sheet material and which, in turn, allows the piercing elements to be inserted into it, keeping the sheet material that is located between this surface and the perforating wheel firm, in a flat position.

These support surfaces can be formed by individual holes coincident with the punches or channels aligned with the protruding piercing elements and allow said piercing elements to be inserted. Said support surfaces can also be made with materials that allow the penetration of the piercing elements on their surface, such as rubber, foam, or the more innovative ones formed by bristles arranged in an appropriate density to withstand the pressure of the perforating wheel and allow in turn an easy insertion of the piercing elements.

This transverse support bristle surface, across the width of the sheet material, is formed by modular bristles of flexible materials; polymers, steels, rubbers, etc., which together form a base where the sheet material rests when perforated with the advantage that this bristle surface is consistent and therefore firmly retains the sheet material, but at the same time, allows being penetrated by the piercing elements of the perforating wheels. Advantageously, this bristle surface allows the perforation to be carried out in any position on the surface indistinctly, therefore, the perforating wheels can vary their position during perforation without altering its durability and functionality.

This is a great advantage, since the surfaces described above require a great synchrony between the piercing elements and the insertion points or channels to avoid the interference of said piercing elements with the support surface, which would cause deterioration thereof by the action of the punches and the breakage of the punches, as well as a failure in the die-cutting of the sheet material.

This combined design of a perforating wheel with a bristle base has technical and economic advantages, the most notable being that it allows a head to be designed where the perforating wheel does not have any position restriction, allowing it to be mobile in any direction, or in tandem and not aligned, etc. since it can penetrate in any position of the base without damaging the micro punches.

Said perforating heads or carriages move transversely across the width of the sheet material, perforating individual sections equivalent to the width of the perforating wheel. This perforating wheel in turn has to be designed and sized according to the longitudinal displacement of the sheet material to ensure that there are no areas without perforation due to this cause.

Multiple perforating heads and multiple perforating wheels can be used to increase throughput and hole density, and micro-holes can be made with close spacing between them. The density of holes can be increased through the position of the perforating wheel, this allows doubling the density while maintaining the number of micro punches of each wheel.

These single or multiple perforating heads allow unidirectional or bidirectional transverse advances (width of the sheet material) opposed to each other.

A possible embodiment with two perforating heads: right head, resting on the right and left head resting on the left of the sheet material, which move transversely across the width of the sheet material, in opposing movements to cover the entire width of the sheet material.

Said right and left heads have opposite movements, which can be carried out with a single mechanical drive (motor) and in this case, the heads are designed in such a way that one of the perforating wheels is retractable through an internal movement of said wheel, on the same transverse axis, which is actuated by the pressure produced when advancing the opposite carriage, so that, although both carriages advance in the opposite direction, on the same axis of movement, there is no area to be perforated.

Another possible embodiment of said opposed movements is to advance these opposed heads with two synchronized drives (motors). This embodiment allows superior performance, by adapting to the width of the sheet material automatically and also perforating its entire width.

The perforating wheels can have a small lateral displacement (2 mm), perpendicular to the direction of advance of the carriage. This movement is activated when the direction of advance of the head is reversed. It can be mechanically actuated, by a system of guided cams, springs, etc. or activated in an external way (solenoid, piston, micromotor, etc.) depending on the design of the head or carriage that houses the perforating wheels.

Said perpendicular lateral displacement of the perforating wheels allows to perforate areas that have not been covered during the first stage of advance of the perforating head, so that when reversing the direction, it perforates the surface of the sheet material in a virgin area that does not coincide with the holes already made and corresponding to the lateral perpendicular displacement of said perforating wheels. In this way, the density of holes can be doubled with the same head, being very advantageous for the application of these sheet materials.

Asynchronous perforation can occur at a time other than the advance of the sheet material necessary to be printed. It requires movement systems separate from those for the advancement of the sheet material since, frequently, the perforation process of the sheet material can coincide with the time interval in which the printing takes place.

Advantageously, said sheet material printing and perforating machine can be a single functional unit, or be composed of joined functional modules: a printing module and a perforation module. Said modular embodiment allows the sheet material perforation module to be installed in existing printing machines, allowing the advantages of the present invention to be added to current machines.

### BRIEF DESCRIPTION OF THE DRAWINGS

For a better understanding of what has been stated, some drawings are attached in which, schematically and only as a non-limiting example, a practical case of embodiment is represented.

In FIG. 1 an embodiment is shown in which the perforation mechanism is located before the printing mechanism.

In FIG. 2 and FIG. 3 an embodiment is shown in which the perforation mechanism is located after the printing mechanism.

In FIGS. 4 and 5 an embodiment is represented in which the perforation mechanism is located before the printing mechanism, in a machine that contains movable bars for the control of the movement of the sheet material.

In FIG. 6 an embodiment is represented in which the perforation mechanism is located after the printing mechanism, in a machine that contains movable bars for the control of the movement of the sheet material.

FIGS. 7a-7g show embodiments of perforating rollers with piercing or die-cutting elements.

FIGS. 8a-8b show a roller with pointed, circular, slightly rectangular, square, triangular micro punches with different shapes, lengths, and sizes.

In FIGS. 9a-9b, 10a-10b, 11a-11b, different possible embodiments of support rollers are shown that allow the piercing elements to be inserted into them.

FIGS. 12a-12b show a roller made of material, such as foam rubber among others, which allows the penetration of piercing elements on its surface.

In FIGS. 13a-13b, two embodiments of perforation by advancement of the sheet material in the longitudinal axis are shown.

FIG. 14 shows an embodiment of perforation by transverse advancement across the width of the perforating head relative to the sheet material.

In FIG. 15, an embodiment of a perforating head with multiple perforating wheels in tandem arrangement is shown.

In FIG. 16, an embodiment of a perforating head is shown, which allows the perforating wheels to move laterally by reversing the direction of advance of said perforating heads.

FIG. 17 shows a detail of the perforating wheels whose piercing elements perforate the sheet material and penetrate the support surface once the sheet material has been perforated.

In FIG. 18, a support surface formed by modules of bristles supported by the guide is shown, forming the support surface for the perforation of the sheet material.

### DESCRIPTION OF PREFERRED EMBODIMENTS OF THE INVENTION

FIGS. 1, 2, 3, 4, 5, 6 are representations, by way of example, of possible embodiments of printing machines in which different possible locations of the perforation mechanism (1) are shown.

In FIG. 1 an embodiment is shown in which the perforation mechanism (1) is located before the printing mechanism (30).

In FIG. 2 and FIG. 3 an embodiment is shown in which the perforation mechanism (1) is located after the printing mechanism (30).

FIGS. 4 and 5 represent an embodiment in which the perforation mechanism (1) is located before the printing mechanism (30), in a machine that contains movable bars (31) for controlling the movement of the sheet material.

In FIG. 6 an embodiment is shown in which the perforation mechanism (1) is located after the printing mechanism (30), in a machine that contains movable bars (31) to control the movement of the sheet material.

Asynchronous perforation can be carried out at a time other than the advance of the sheet material-necessary to be printed-, varying according to the position of the perforation mechanism (1). It requires movement systems separate from those of the advancement of the sheet material since full or partial printing range to perforate the sheet material shown in FIGS. 4 and 6 is used.

The printing mechanism (30) of the printing and perforating machine according to the present invention is not described in detail for simplicity reasons because it can be conventional printing mechanism well known in the art.

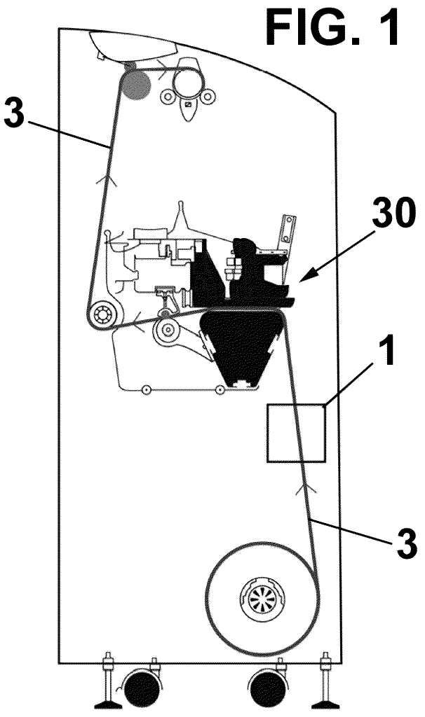

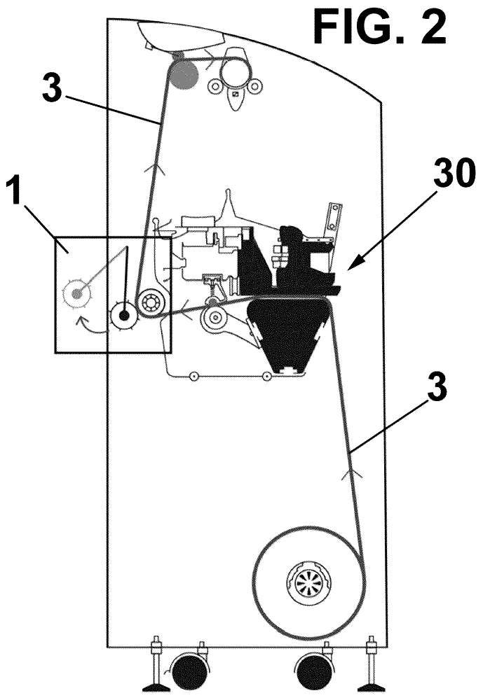

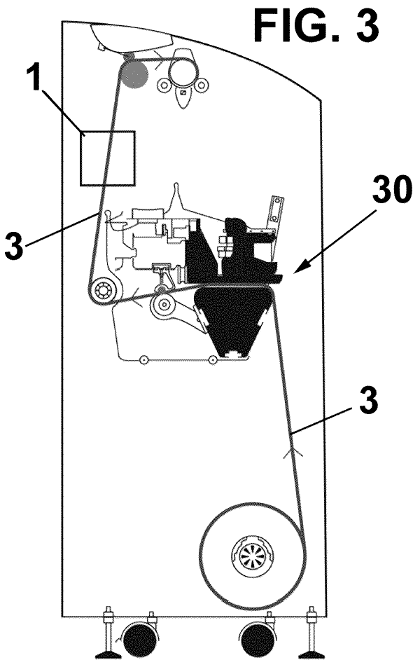

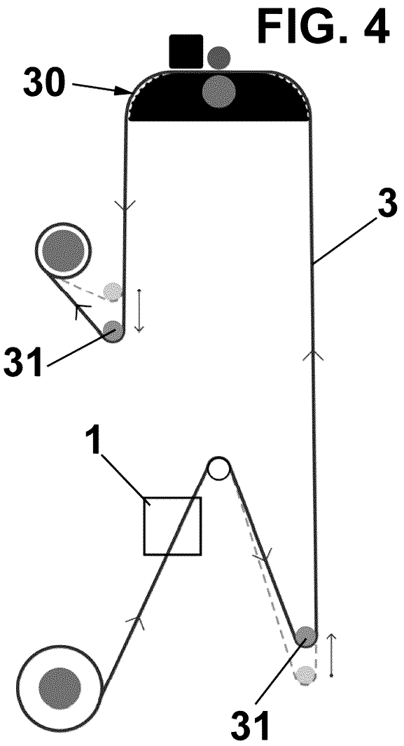

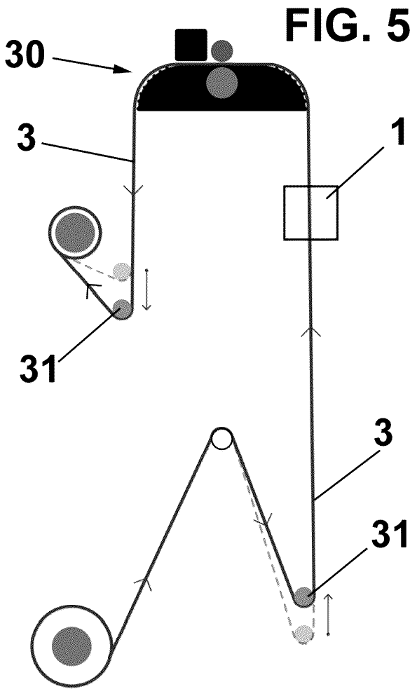

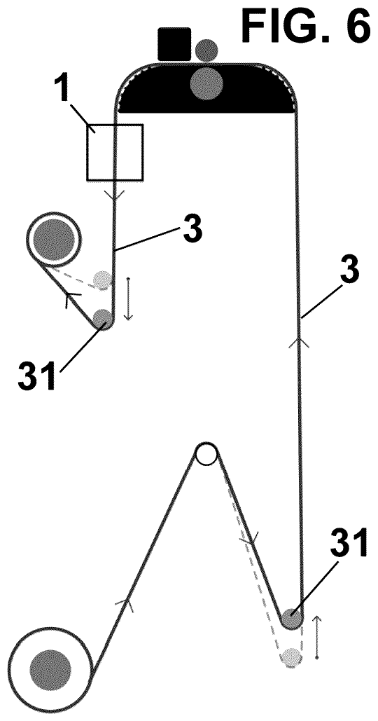

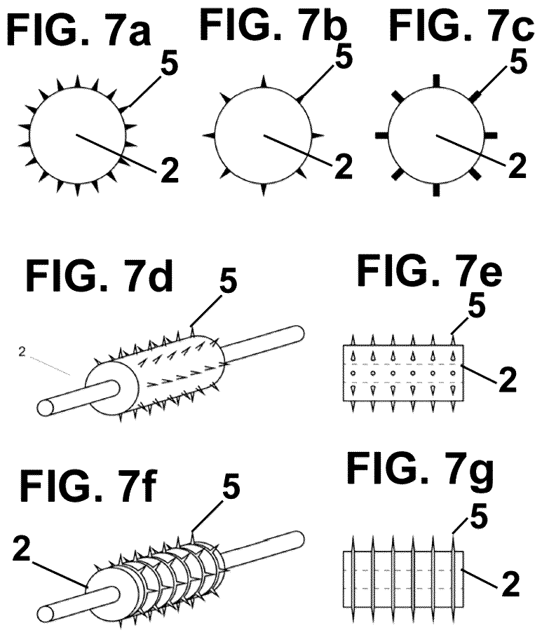

FIGS. 7a-7g shows different embodiments of perforating rollers (2) with piercing or die-cutting elements (5).

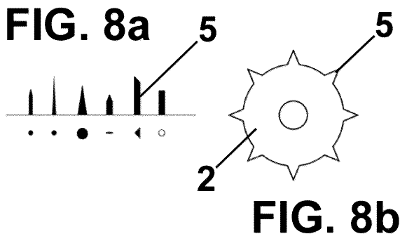

Said perforating rollers (2) have piercing elements (5) arranged on their surface. These are pointed, circular, slightly rectangular, square, triangular micro punches with different shapes, lengths and sizes using bar, rolled, drawn, injected materials etc. suitable for perforation as shown in FIGS. 8a-8b, and are arranged on the roller with the desired spacing between them, as shown in FIGS. 7a-7g to obtain a perforation with the shape and size of the hole, as well as with the desired spacing between holes.

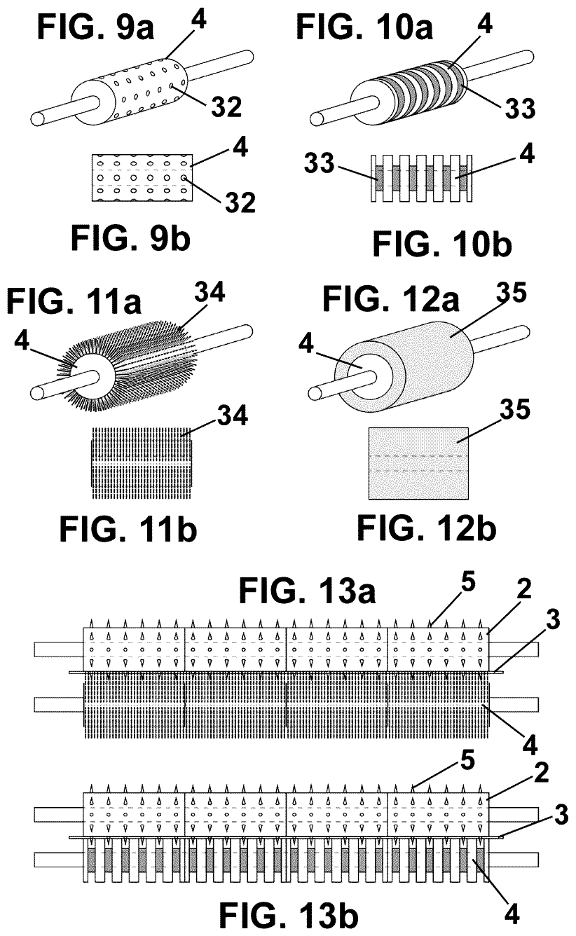

In FIGS. 9a-9b, 10a-10b, 11a-11b, 12a-12b, different possible embodiments of support rollers (4) are shown that allow the piercing elements to be inserted into them. These support rollers (4) can be formed by individual holes (32), FIGS. 9a-9b, channels (33) that coincide with the protruding piercing elements (5) where they are inserted, FIGS. 10a-10b, formed by bristles (34) arranged with the appropriate density on their surface, FIGS. 11a-11b, or in materials that allow penetration into their surface of piercing elements such as foam rubber (35), among others, as shown in FIGS. 12a-12b.

By way of example, FIGS. 13a-13b show two embodiments of advance perforation of the sheet material in the longitudinal axis. The perforation of the sheet material (3) is carried out through a perforating roller (2) and a support roller (4) of the sheet material (3) that allows the penetration of the piercing elements (5). The perforation is carried out during the longitudinal movement of the sheet material (3).

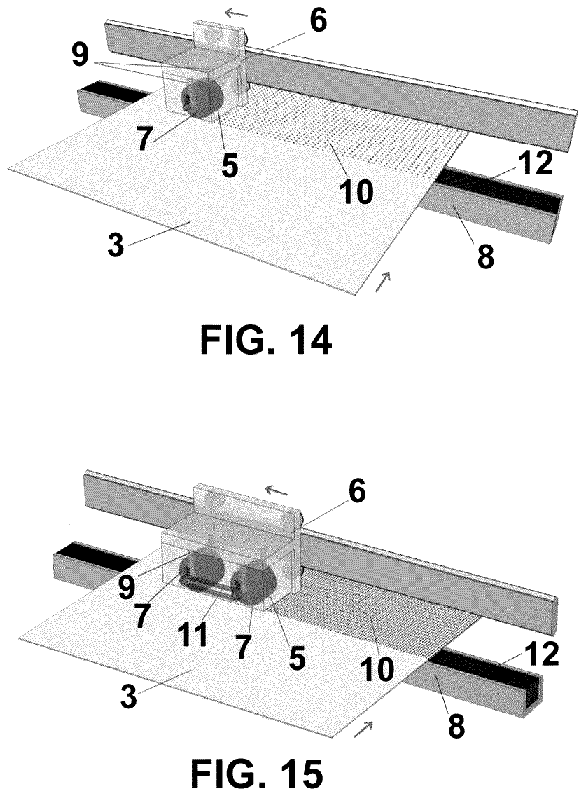

FIG. 14 shows an embodiment of perforation by transversal advance across the width, of the perforating head (6) with respect to the sheet material (3).

The perforating head (6) contains a perforating wheel (7), formed by piercing elements (5) arranged on its surface, these piercing elements (5) are similar to those shown in FIGS. 7a-7g and 8a-7b. These are micro punches or sharp plates being pointed, circular, slightly rectangular, square, triangular, die-cut that does not end in a point, etc., as shown in FIGS. 8a-8b. These piercing elements (5) protrude slightly from the surface of the perforating wheel (7), this distance being the one that penetrates the sheet material (3), piercing it, and also penetrating a support surface (8), preferably formed by modules having bristles (12) and defining a longitudinal axis.

The design and size of the perforating wheel (7) will be made according to the longitudinal displacement of the sheet material (3) to ensure that there are no areas without perforation due to this cause.

The perforating head (6), FIG. 14, regardless of whether they are individual or hybrid, have pressing elements (9) that press the perforating wheels (7) to ensure that the forces necessary for the perforation of the sheet material (3) are applied to the perforating wheels (7) along the entire transversal path of the perforating head (6), guaranteeing the perforation and ensuring the correct size of the holes (10) made by the perforating head (6).

In FIG. 15 an embodiment of a perforating head (6) with multiple perforating wheels (7) in tandem arrangement is shown. A mechanical coupling (11) is used to keep the two perforating wheels (7) synchronized and to obtain evenly spaced holes (10) giving rise to a homogeneous perforation.

FIG. 16 shows an embodiment of a perforating head (6), which allows the perforating wheels (7) to move laterally by reversing the direction of advance of said perforating heads. This slight lateral or diagonal displacement, shown by arrows A and B, is perpendicular to the direction of advance of the perforating head (6), i.e., diagonal with respect to the longitudinal axis of the support surface (8), being actuated when the direction of advance of the head is reversed through various cams or angular slots (15). This lateral movement allows the perforating wheel (7) to make holes in different positions according to the direction of advance of the perforating head (6).

As shown in FIG. 16, the holes (13) are made when the perforating wheel (7) undergoes a lateral displacement (arrow A) as a result of the movement towards the left (arrow C) of the perforating head (6), and the holes (14) group said holes (13) in addition to the holes made when the perforating wheel (7) undergoes a lateral displacement (arrow B) as a result of the movement towards the right (arrow D) of the perforation head (6), once the direction of advance has been reversed shifting from moving towards the left (arrow C) to moving towards the right (arrow D).

In this way, the density of holes can be doubled with the same perforating head (6), being very advantageous for the application of these sheet materials.

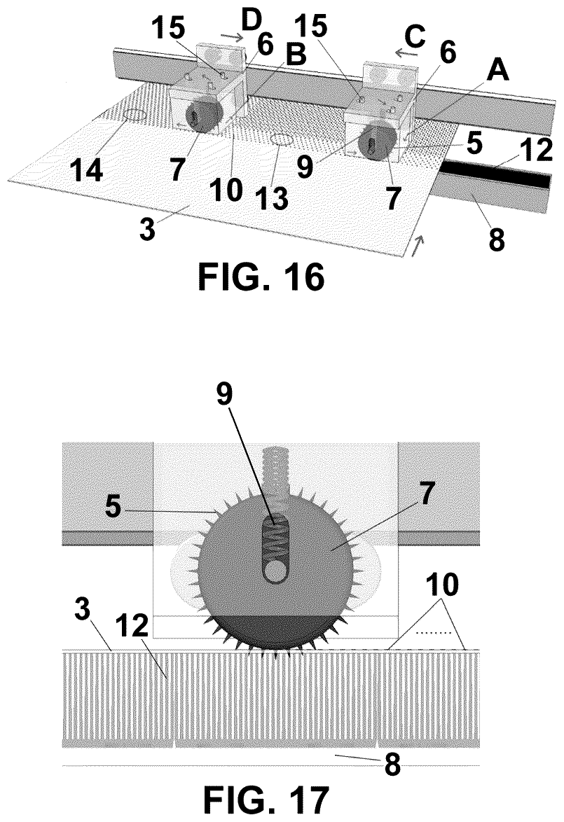

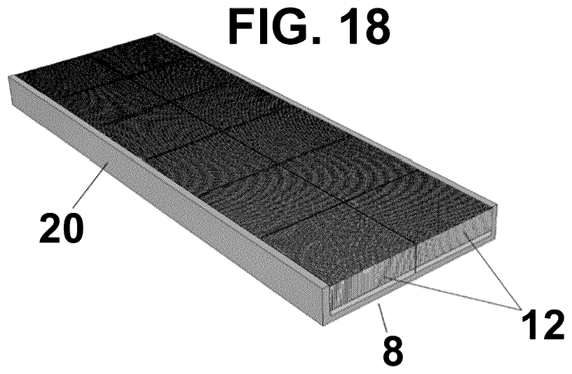

FIG. 17 shows a detail of the perforating wheels (7) whose piercing elements (5) perforate the sheet material (3) and penetrate the support surface (8) once the sheet material (3) has been perforated.

Said perforating wheels (7) can contain piercing elements (5) of different shapes, lengths, and sizes, as shown in FIGS. 8a-8b, and they can be arranged on the perforating roller (2) with the desired spacing between them, as shown in FIGS. 7a-7g to obtain a perforation with the shape and size of the hole, as well as the desired hole spacing.

This support surface (8) is formed by modules having bristles (12) supported by a guide (20) forming the support surface (8) for the perforation of the sheet material (3), as shown in FIG. 18. Also, the bristle (12) modules allow the support surface (8) to adapt its sizes according to the displacement necessary for digital printing of the sheet material (3) and its width.

Despite the fact that reference has been made to a specific embodiment of the invention, it is obvious to a person skilled in the art that the described printing machine is susceptible to numerous variations and modifications, and that all the mentioned details can be substituted by others being technically equivalents, without departing from the scope of protection defined by the appended claims.

1: Printing and perforating machine, comprising a perforating mechanism (1) and a printing mechanism (30),
characterized in that the perforating mechanism (1) comprises:
a perforating element (2, 7) provided with piercing elements (5); and
a support element (4, 8) that defines with the perforating element (2, 7) a space for the passage of a sheet material (3), forming holes on the sheet material (3) when it passes through this space.

2: Printing and perforating machine according to claim 1, wherein the perforating element comprises at least one perforating wheel (7) provided with the piercing elements (5), said perforating wheel (7) being movable along the support element (8).

3: Printing and perforating machine according to claim 2, wherein the perforating element comprises two perforating wheels (7) coupled to each other by a mechanical coupling (11).

4: Printing and perforating machine according to claim 2, wherein the at least one perforating wheel (7) is mounted on a perforating head (6).

5: Printing and perforating machine according to claim 4, wherein it comprises two perforating heads (6) that are movable to each other.

6: Printing and perforating machine according to claim 4, wherein the support element (8) defines a longitudinal axis, and the perforating head (6) is movable diagonally with respect to the longitudinal axis of the support element (8).

7: Printing and perforating machine according to claim 4, wherein the perforating head (6) comprises a pressing element (9) that presses the perforating wheel (7) against the sheet material (3).

8: Printing and perforating machine according to claim 1, wherein the support element (4, 8) comprises bristles (12, 34).

9: Printing and perforating machine according to claim 8, wherein the bristles are formed by modules (12).

10: Printing and perforating machine according to claim 1, wherein the perforating element is a perforating roller (2) and the support element is a support roller (4).

11: Printing and perforating machine according to claim 9, wherein the support roller (4) comprises holes (32), channels (33), bristles (34), or foam rubber (35).
